(19) United States
(12) Patent Application Publication
(10) Pub. No.: US 2007/0250505 A1
(43) Pub. Date: Oct. 25, 2007

(54) METHOD AND APPARATUS FOR DEFINING A WORKFLOW

(75) Inventors: BRIAN YANG, ALAMEDA, CA (US); TIMOTHY BOLGER, VALLEJO, CA (US); COREY GUNNELL, ST. LOUIS, MO (US); ANIRUDH YADAV, SAN RAMON, CA (US); JEFF YUEN, LAFAYETTE, CA (US); ALAN LAW, SAN LORENZO, CA (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/380,072

(22) Filed: Apr. 25, 2006

(51) Int. Cl. G06F 17/30

(52) U.S. Cl. 707/7

(57) ABSTRACT

An apparatus and method are disclosed for defining a workflow. An apparatus that incorporates teachings of the present disclosure may include, for example, a computing device can have a controller programmed to organize one or more active objects selected from a content source according to a plurality of operational paradigms to construct a workflow, and present a graphical user interface (GUI) comprising a hierarchical structure of the workflow. Additional embodiments are disclosed.

### RELATED APPLICATIONS

U.S. Patent Application, filed Mar. 30, 2006, by Bolger et al., entitled “Message-Oriented Divergence and Convergence of Message Documents,” incorporated herein by reference in its entirety.

U.S. Patent Application, filed Apr. 25, 2006, by Yang et al., entitled “Method and Apparatus for Importing Content in a User-Defined Workflow,” incorporated herein by reference in its entirety.

U.S. Patent Application, filed Apr. 25, 2006, by Robert Gulledge, entitled “Method and Apparatus for Configuring a Workflow,” incorporated herein by reference in its entirety.

### FIELD OF THE DISCLOSURE

The present disclosure relates generally to workflow techniques, and more specifically to a method and apparatus for defining a workflow.

### BACKGROUND

The Internet and other means of mass communications have made it extraordinarily simple to distribute large amounts of content to end users. Managing high volumes of content in a manner that can be acted on in a productive manner can be challenging. Applications such as Microsoft's Windows Explorer and Internet Explorer provide a means for end users to manage such content under independent operational paradigms.

With Internet Explorer for instance an end user can browse content between remote servers in a well defined operational paradigm managed in part by a Hyper Text Transfer Protocol or HTTP. Windows Explorer on the other hand allows end users to browse elements of one or more file systems (e.g., files, folders, or directories) under another operational paradigm managed in part by Microsoft's NT File System (NTFS) protocol. Although these paradigms can be made to interact, there is no unique way for an end user to readily define combinations of these and other operational paradigms in a workflow.

A need therefore arises for a method and apparatus for defining a workflow.

### BRIEF DESCRIPTION OF THE DRAWINGS

FIG. 1 depicts an exemplary embodiment of a communication system;

FIG. 2 depicts an exemplary embodiment of one or more computing devices operating in the communication system;

FIG. 3 depicts an exemplary method operating in or more of the computing devices;

FIG. 4 depicts exemplary illustrations of graphical user interfaces (GUIs) corresponding to the embodiments of the method illustrated in FIG. 3 ; and

FIG. 5 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for defining a workflow.

In a first embodiment of the present disclosure, a computer-readable storage medium can have computer instructions for structuring content into one or more active objects according to a plurality of operational paradigms selected by an end user to construct a workflow, presenting to an end user a graphical user interface (GUI) comprising a hierarchical structure corresponding to the workflow, and invoking at least one application in response to a selected action applied by the end user to at least a portion of the hierarchical structure.

In a second embodiment of the present disclosure, a computing device can have a controller programmed to organize one or more active objects selected from a content source according to a plurality of operational paradigms to construct a workflow, and present a graphical user interface (GUI) comprising a hierarchical structure of the workflow.

In a third embodiment of the present disclosure, a method can generate a grouping structure from a workflow constructed with one or more active objects derived from content having a plurality of operational paradigms.

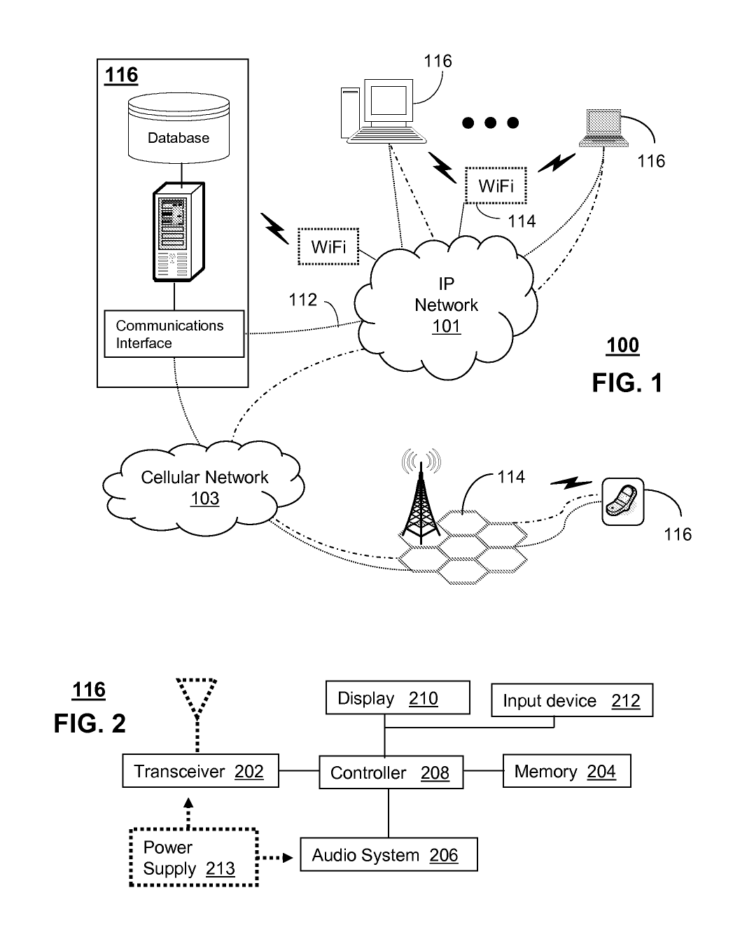

FIG. 1 depicts an exemplary embodiment of a communication system 100. The communication system 100 can comprise a plurality of computing devices (CD) 116 represented by any number of embodiments including a desktop computer, a cellular phone, a laptop computer, or a scalable server coupled to wired and/or wireless access points 112, 114.

Wired access points 114 can comprise a plain old telephone services (POTS) interface, a digital subscriber line (DSL) interface, a cable data communications interface, an optical communications interface, a T-carrier line (T1, T2, etc.) or any other suitable means for wired communications. The wired access points 114 can carry voice and/or data communications according to the present disclosure.

The wireless access points 114 can be depicted by a number of embodiments including a plurality of cellular base stations supporting wireless voice and/or data communications in a cellular network 103, and/or one or more Wireless Fidelity (WiFi) access points operating in a commercial enterprise, retail store, residence, or otherwise. The cellular network 103 can utilize circuit-switched technology that supports voice and data services such as GSM-GPRS, EDGE, CDMA-1X, EV/DO, UMTS, and other known and next generation cellular communications technologies. The cellular network 103 utilizes a frequency-reuse architecture for communicating over-the-air with roaming CDs 116 over an expansive area. The WiFi access points can conform to any one of IEEE's 802.11 present and next generation protocols (e.g., IEEE 802.11 a, b, g, n) and can operate individually or in a mesh network.

Alternatively, or in combination, other wireless access technologies can be applied to the present disclosure such as, for example, a Worldwide Interoperability for Microwave Access (WiMAX), ultra wide band (UWB), Bluetooth™, and software defined radio (SDR). SDR provides a means to access public and private communication spectrum with any number of communication protocols that can be dynamically downloaded over-the-air to the CD 116. Other present and future generation wireless access technologies can also be used in the present disclosure.

The communication system 100 can further comprise an IP (Internet Protocol) network 101 that couples to the CDs 116 for carrying Internet traffic therebetween. In yet another embodiment of FIG. 1 (not shown), the IP network 101 can be replaced with an Intranet network or a common local area network (LAN) in which case the CDs 116 and a number of access points 114 (e.g., WiFi's and/or Ethernet ports) operate within an enterprise or residential environment according to the present disclosure.

FIG. 2 is an exemplary block diagram of the CD 116. The CD 116 can utilize a common wired transceiver 202 coupled to any of the aforementioned wired interface technologies (e.g., a POTS modem, a DSL modem, a cable modem, etc.). Alternatively, or in combination the CD 116 can include short range wireless communications technology in the transceiver 202 such as used by cordless phones, Bluetooth or WiFi devices to support mobility within a small area such as the end user's residence or enterprise.

The transceiver 202 can be further supplemented with technology that supports mid to long-range wireless communications with the wireless access points 114 by way of cellular, WiMAX, or SDR technologies. The CD 116 can also operate as a multimode device. That is, when the CD 116 is within a building it can perform communication activities over a wired DSL interface, a POTS interface, WiFi, or Bluetooth™ interfaces, and so on. One or more of these interfaces can in turn support data communications, Voice over IP (VoIP) communications by way of the IP network 101, and POTS voice messaging. When roaming outside the building, the CD 116 can exchange data and voice messages over the cellular network 103 or other long-range networks such as WiMAX.

Each of the foregoing embodiments for the CDs 116 can utilize a memory 204, an audio system 206, and a controller 208 among other possible components. The memory 204 can comprise storage devices such as RAM, SRAM, DRAM, and/or Flash memories. The memory 204 can be external or an integral component of the controller 208. The audio system 206 can be utilized for exchanging audible signals with an end user. The CD 116 can further include a display 210 for conveying images to the end user, an input device 212 (such as a keypad and mouse) for manipulating operations of the CD 116, and a portable power supply 213. The audio system 206, the display 210, and the input device 212 can singly or in combination represent a user interface (UI) for controlling operations of the CD 116 as directed by the end user. The controller 208 can manage the foregoing components by utilizing computing technology such as a microprocessor and/or digital signal processor.

In a distributed processing environment, the controller 208 can represent a plurality of processors. Under this embodiment a computing device may be described as a laptop computer representing a first processor interacting with a server as a second processor each performing a variety of tasks that collectively produce an end result. Accordingly, the present disclosure can be applied to a single processing unit operating in a centralized computing environment, or a plurality of processing units in a decentralized computing environment which singly or in combination represent a computing device.

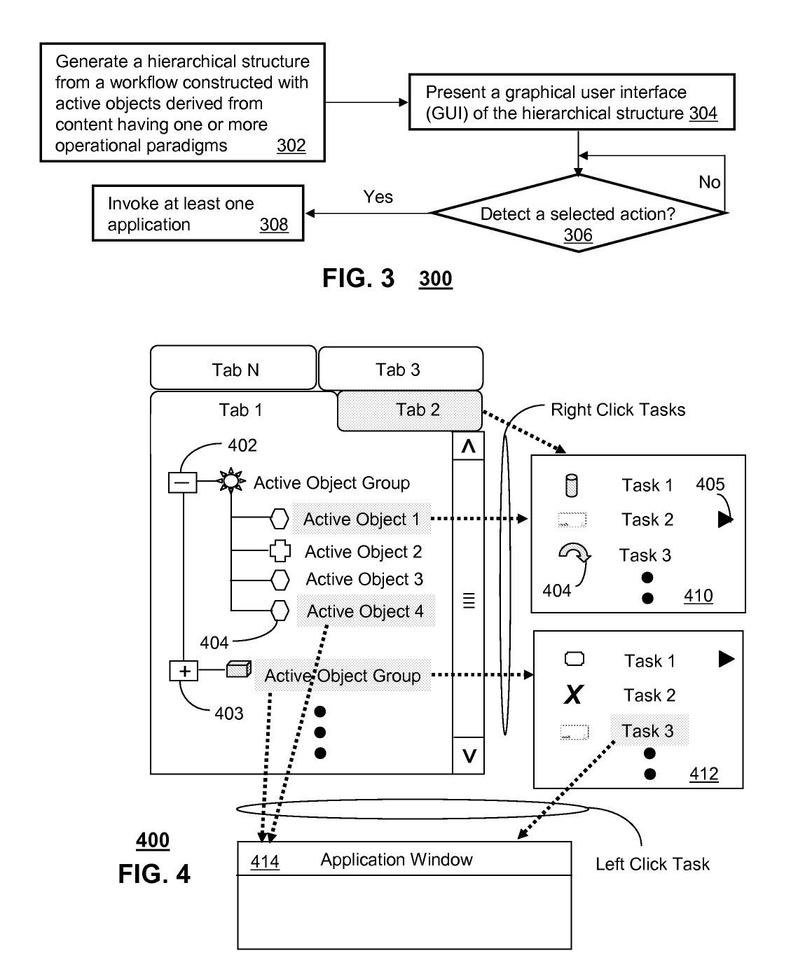

FIG. 3 depicts an exemplary method 300 operating in the CDs 116, while FIG. 4 depicts an exemplary illustration of graphical user interfaces (GUIs) 400 corresponding to embodiments of method 300. Method 300 can begin with step 302 in which the controller 208 can be programmed to generate a grouping structure from a workflow constructed with active objects derived from content having one or more well-known operational paradigms. The grouping structure shown in FIG. 4 illustrates a hierarchical structure. It would be evident to an artisan with ordinary skill in the art that other structures can be applied to the present disclosure without departing from the scope of the claims listed below. For instance, a cluster-oriented grouping structure can be used so that end users can arrange their own logical mapping of active objects. End users can create a cluster of active objects similar to the way icons can be grouped on a desktop as logical clusters. Accordingly, a grouping structure can represent any containment format suitable to an end user. For illustration purposes only, the present disclosure will focus on hierarchical structures.

The aforementioned content can comprise without limitation any form of actionable content such as an email address (e.g., xxx.yyy@zzz.com), an instant messaging (IM) address (e.g., xxx.yyy@zzz.com), a domain name (e.g., zzz.com), a hyperlink (e.g., “News” hyperlink in Google), a web page (e.g., http://www.google.com/), a file system link to for example an image file, a Word file, a Zip file, a Power Point file, an Excel file, a directory, a folder, and so on.

The above content types can be managed in a number of operational paradigms such as, for example, a file system browsing paradigm (e.g., Microsoft Windows Explorer), a remote server browsing paradigm (e.g., Microsoft Internet Explorer), an operating system management paradigm (e.g., Microsoft Windows XP), a data management paradigm (e.g., a database, a customer relationship management application), and a communications management paradigm (e.g., circuit-switched voice communications, VoIP communications, short message service or SMS communications, email, instant messaging, chat room messaging, and so on). The aforementioned workflow can operate singly or in combination with any of these operational paradigms in a hierarchical structure of active objects presented in step 304 to an end user by way of one or more related GUIs shown in FIG. 4.

This is a significant paradigm shift from prior art systems. Prior art systems such as Microsoft Internet Explorer and Microsoft Windows Explorer utilize operational paradigms with independent workflows. For instance, Microsoft Internet Explorer provides a single operational paradigm in which an end user can browse content between remote servers by way of the Internet. Microsoft Windows Explorer on the other hand provides a single operational paradigm in which an end user can browse content in a local or remote file system utilizing a common directory structure.

Although the operational paradigms of Windows Explorer and Internet Explorer have been designed to share resources, the end user has no flexibility to redefine these paradigms such as by combining them into a single workflow as illustrated in FIG. 4. Accordingly, an end user cannot without significant difficulty extensively browse the Internet from Windows Explorer, nor can an end user without similar difficulty extensively explore a file system by way of Internet Explorer. Similarly, these applications cannot be readily redefined to create a communications management paradigm such as by invoking an instant messaging application from within the same operational paradigm. Other prior art systems such as found in Linux and Apple computing systems have similar limitations.

With these limitations in mind, the reader's attention is directed back to FIG. 4. In this illustration, the hierarchical structure can have as many levels of active objects as desired. The active objects as noted earlier can be email addresses, IM addresses, file system links, chat room addresses, SMS email addresses, a person's office number, cell phone number, and so on. Although these active objects can be used in independently operated paradigms such as described earlier, the hierarchical structure of FIG. 4 provides the end user a novel means to combine operational paradigms in a single workflow.

Tab 1 for example can represent a workflow. Within this tab the active objects can be grouped in a nested or flat structure. In a nested structure, a group of active objects (i.e., an active object group) can have a logical representation. For example, one group of active objects can logically represent a chat room, another a file system, another an instant messaging list, another a work project group, another a web link group, and so on. The active objects of each active object group can also have a logical association with each other. For instance, a chat room group can have active objects representing members of the chat room, an instant messaging group can have a grouping of instant messaging contacts, a work project group can have members belonging to a specific work project team, a web link group can have a grouping of web links having a logical association (such as music hyperlinks, news hyperlinks, entertainment hyperlinks, etc.).

Alternatively, the active object groups can have hybrid associations. For instance, an active object group representing a work project group may have a list of members, each member having nested active objects representing the member's cell phone number, office number, work address, home address, home number, email address, IM address, short message service (SMS) address, work project files relating to the member's assigned tasks, and so on. Such a structure can provide the end user of the team a powerful means for associating with each of the other members of the work project team.

Each active object can also have an associated iconic symbol 404 to assist an end user in visually identifying an active object type. Similarly, iconic symbols 404 can be used to identify tasks that can be applied to the active object as a selectable actions associated with one or more task menus 410, 412.

The hierarchical structure can have an expansion icon 402, a collapse icon 403, and a nested icon 405. As noted earlier, each tab can represent a workflow defined by the end user within the hierarchical structure. Each workflow can therefore represent portions of the hierarchical structure apportioned to each tab by the end user. It should be further evident from the illustration of FIG. 4 that any level of the hierarchical structure can serve as an active object. Accordingly, an end user can selectively perform an action on a tab, on an active object group, and/or an active object.

Selections can take place graphically by way of a common mouse integrated in the input device 212 having, for example, two selectable buttons (a left and right button). To assist the selection process, tabs, active object groups, and active objects can be named by the end user as desired or by the controller 208. In the latter case, for example, the controller 208 can be programmed to extract Joe Smith from an email address such as Joe.Smith@company.com, and thereby name the active object Joe Smith as a representation of said email.

A tab, an active object group, or an active object can be selected by placing a mouse pointer over any of these objects and left clicking or right clicking the mouse buttons. Upon detecting in step 306 a single or double click of the left button using common software and hardware techniques, the controller 208 can be programmed in step 308 to invoke a default application associated with the type of active object selected.

For example, in a case where an active object represents a person having communication information associated therewith, the controller 208 can be programmed to invoke an IM application as a default application that presents a separate GUI window 414 to the end user to begin an instant messaging session with the selected individual. Alternatively, other applications can be defined as a default application. For instance, instead of invoking an IM application, the controller 208 can be programmed to invoke a chat room application. A default application can be defined by the end user or an administrator of method 300.

The aforementioned default application can be invoked by soliciting one or more applications by way of an operating system managing the resources of the CD 116, or by other common means for initiating an application. It should be noted that an application in the present context can mean software, hardware or combinations thereof.

In yet another embodiment, the controller 208 can detect in step 306 a right click of the mouse button on a selected active object. In this instance, a more extensive list of selectable actions can be presented to the end user (see references 410, 412). The tasks listed in 410 or 412 can depend on the active object selected. Additionally, tasks within these menus can be nested (see reference 405). To select a task the end user can place the mouse pointer over a desired task and select an action with a left click of the mouse button which in turn can invoke in step 308 an application window 414 or cause an update of the hierarchical structure without a displayable GUI. In the latter case, an application window 414 may not be necessary for common tasks such as deleting an active object (e.g., delete a member from a chat room).

Method 300 can invoke innumerable applications in accordance with the present disclosure. For instance, an application in the present context can represent without limitation an operating system application, a paging application or short message service (SMS) application, an email application (e.g., Microsoft Outlook), an instant messaging application (e.g., MSN Messenger), a chat room application, an editing application (e.g., Microsoft Word), a spreadsheet application (e.g., Microsoft Excel), a presentation application (e.g., Microsoft Power Point), a document formatting application (e.g., Adobe Acrobat), a browser application (e.g., Microsoft Internet Explorer), a statistical application, a database application (e.g., Oracle, or Microsoft Access), a voice messaging application (e.g., a voice POTS or VoIP call), a video application (e.g., Microsoft NetMeeting, Microsoft Windows Media Player), or a file system application (e.g., Microsoft Windows Explorer), just to name a few.

Alternatively, said applications can be in whole or in part an integral aspect of method 300. For instance, computer instructions corresponding to method 300 can include an instant messaging application in which case an instant messaging session can be invoked without requesting said application by way of an operating system. Accordingly, method 300 can comprise any number of internal applications which can be invoked in real-time. External applications on the other hand can be invoked by method 300 by way of an operating system.

Thus method 300 can be utilized for any number of applications such as for example transmitting pages to cell phone users upon selecting a task in GUI 410, invoking voice and/or video messaging session between end users, and/or forwarding to new or existing members one or more tabs, an active object group within a tab, or portions thereof by email or other data transfer means.

Method 300 can also be used for publishing and sharing portions of the hierarchical structure 400 of FIG. 1 between members of a particular active object group, or between active object groups. For instance, an active object group designated as Work Project Team A can share portions of active objects in its group with Work Project Team B of another active object group, and vice-versa. Additionally, method 300 can be used for selecting an active object such as a person and invoke an application that retrieves information about the person from a corporate directory or a local information source such as contact entries in Microsoft Outlook, Lotus Notes, and so on.

For an active object group representing a chat room, the end user can also use method 300 to select a task such as to attend a chat room meeting, or view a conversation history from a selectable list of previous chat room sessions. An end user can also apply method 300 to view the properties of a tab, active object group, or an active object such as for instance its file size, application type, and so on, by selecting a task in menus 410 or 412.

When application 414 is invoked in response to an end user selecting an active object or task associated therewith, the application 414 can be programmed to display portions of the hierarchical structure concurrently thereby providing the end user additional selectable options such as for example forwarding portions of the hierarchical structure to targeted parties, sending individual or broadcast emails, or SMS messages, sending invitations to other members of the active object group to begin an IM or chat room session, and so on. Each task menu 410, 412 can also display a help task to assist the end user when s/he needs assistance understanding the function of a displayed task.

It should be evident to an artisan with ordinary skill in the art that the uses for a grouping structure of active objects having one or more operational paradigms as described above can have endless variants and therefore cannot all be described in the present disclosure. For instance, a number of applications can be programmed to supply information status to one or more of the active objects of FIG. 4. The application can be operating on a remote server which provides status information (such as available for use or “active”, or unavailable for use or “inactive”). The status information can in turn be used as a variant of method 300 to dynamically change the icon associated with one or more of the active objects thereby notifying the end user of the active object's status. It would be apparent therefore to said artisan that the embodiments disclosed herein can be rearranged, modified, reduced, or enhanced without departing from the scope and spirit of the claims described below. The reader is therefore directed to the claims for a fuller understanding of the breadth and scope of the present disclosure.

It should be further noted that although the present disclosure refers to Microsoft applications such as Microsoft's Internet Explorer and Window's Explorer any other Internet browser application and/or file system shell can be applied to method 300 as described above within the scope of the claims described below.

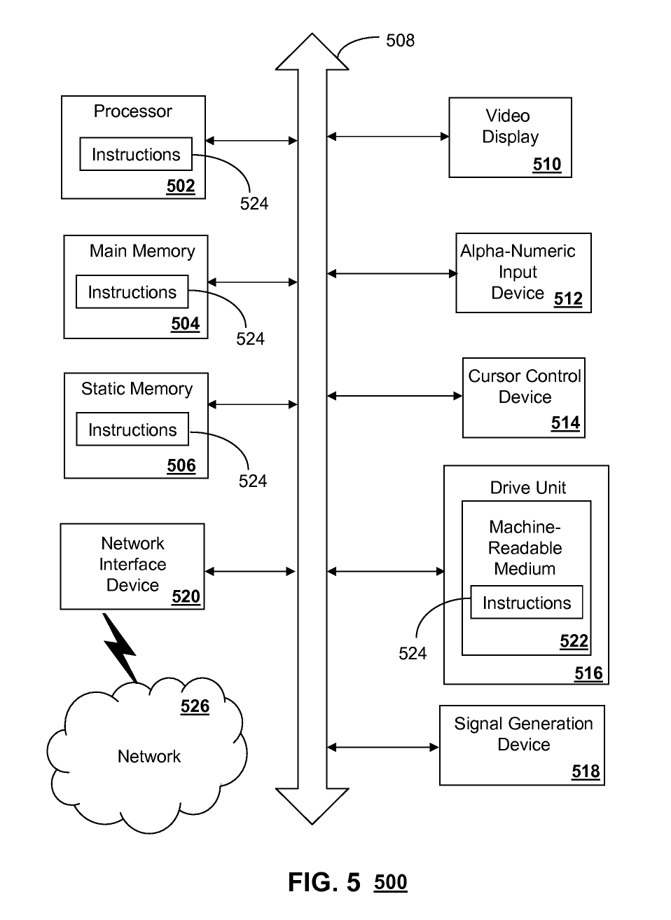

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
structuring content into one or more active objects according to a plurality of operational paradigms selected by an end user to construct a workflow;
presenting to an end user a graphical user interface (GUI) comprising a hierarchical structure corresponding to the workflow; and
invoking at least one application in response to a selected action applied by the end user to at least a portion of the hierarchical structure.

2. The storage medium of claim 1, wherein the plurality of operational paradigms comprises at least two among a file system browsing paradigm, a remote server browsing paradigm, an operating system management paradigm, a data management paradigm, and a communications management paradigm.

3. The storage medium of claim 1, comprising computer instructions for detecting the selected action on at least one among a level of the hierarchical structure, and one or more of the active objects of the hierarchical structure.

4. The storage medium of claim 1, comprising computer instructions for detecting the selected action as one or more tasks applied to the hierarchical structure.

5. The storage medium of claim 4, comprising computer instructions for presenting at least one additional GUI corresponding to the one or more tasks associated with the selected action.

6. The storage medium of claim 1, comprising computer instructions for adjusting the GUI in response to a request by the end user to expand or collapse a view of one or more levels of the hierarchical structure.

7. The storage medium of claim 1, comprising computer instructions for presenting at least one additional GUI corresponding to the one or more applications invoked.

8. The storage medium of claim 1, wherein each of the plurality of applications comprise at least one among a software application and a hardware application.

9. The storage medium of claim 1, comprising computer instructions for submitting a request to an operating system to invoke the one or more applications.

10. The storage medium of claim 1, wherein the one or more applications comprise at least one among a group of applications comprising a communications application, a browser application, a file system application, a content management application, a database application, and an operating system application.

11. The storage medium of claim 10, wherein the communications application comprises at least one among a data messaging application, a paging application, a short message service (SMS) application, a voice messaging application, a video messaging application, an email application, an instant messaging application, a desktop sharing application, and a chat room application.

12. The storage medium of claim 10, wherein the content management application comprises at least one among an editing application, a spreadsheet application, a presentation application, and a document formatting application.

13. The storage medium of claim 1, wherein the selected action corresponds to at least one among a request submitted to the one or more applications to transfer one or more active objects in the portion of the hierarchical structure to one or more target end users, and to initiate communications between the end user and one or more targeted end users identified by one or more active objects in the portion of the hierarchical structure.

14. A computing device, comprising a controller programmed to:
organize one or more active objects selected from a content source according to a plurality of operational paradigms to construct a workflow; and
present a graphical user interface (GUI) comprising a hierarchical structure of the workflow.

15. The computing device of claim 14, wherein the controller is programmed to invoke at least one application in response to a selected action applied to a portion of the hierarchical structure.

16. The computing device of claim 14, wherein the controller comprises a plurality of processors each programmed to perform different portions of the foregoing steps.

17. The computing device of claim 16, wherein the plurality of processors operate in a distributed network.

18. The computing device of claim 15, wherein the controller is programmed to detect the selected action at one or more levels of the hierarchical structure.

19. The computing device of claim 15, wherein the controller is programmed to:
detect the selected action as one or more tasks applied to the hierarchical structure; and
present one or more additional GUIs corresponding to the one or more tasks.

20. The computing device of claim 14, wherein the controller is programmed to adjust the GUI in response to a request to expand or collapse a view of one or more levels of the hierarchical structure.

21. The computing device of claim 15, wherein the controller is programmed to submit a request to an operating system to invoke the one or more applications.

22. A method, comprising generating a grouping structure from a workflow constructed with one or more active objects derived from content having a plurality of operational paradigms.

23. The method of claim 22, comprising the step of invoking at least one software application in response to a selected action applied to the grouping structure.

24. The method of claim 22, comprising the step of sharing at least a portion of the grouping structure with a remote device.

25. The method of claim 22, comprising the step of presenting a graphical user interface (GUI) representing the grouping structure.

26. The method of claim 25, wherein the GUI comprises one or more tabs each depicting a different portion of the grouping structure, and wherein each tab comprises one or more iconic symbols associated with one or more levels of a corresponding portion of the grouping structure.

27. The method of claim 26, wherein each of the iconic symbols comprises a visual message.

28. The method of claim 22, wherein the content comprises at least one among an email address, a domain name, an instant messaging address, a hyperlink, a web page, a chat room link, a uniform resource locator (URL) link, and a file system link.

29. The method of claim 22, comprising:
receiving status information from an application associated with one or more of the active objects; and
updating the grouping structure according to said status information.

30. The method of claim 22, wherein the workflow comprises a logical structure defined by an end user, and wherein the method comprises the step of presenting in a graphical user interface (GUI) the grouping structure according to said logical structure for engaging said end user to select one or more of the active objects.
